(19) United States
(12) Patent Application Publication
(10) Pub. No.: US 2002/0120510 A1
(43) Pub. Date: Aug. 29, 2002

(54) Information consuming system and program with a refund capability, and information package for use therein

(76) Inventor: Hidehiko Kawakami, Nagoya (JP)

Correspondence Address: LAW OFFICE OF DAVID G POSZ, 2000 L STREET, N.W., SUITE 200, WASHINGTON, DC, 20036, US

(21) Appl. No.: 10/053,667

(22) Filed: Jan. 24, 2002

(30) Foreign Application Priority Data
Feb. 27, 2001 (JP) 2001-52415

(51) Int. Cl. G06F 17/60

(52) U.S. Cl. 705/14

(57) ABSTRACT

A consuming device effects a specific function by using a content of an information package containing a plurality of charged contents while permitting a user to get a refund in response to the amount of actually used contents. A used content ID list of IDs of charged contents having been used so far is stored in nonvolatile memory in such a way as prevents the list from being altered by any person. If a content to be used has never been used until then, the ID of the content is added to used content ID list. The user can get a refund according to the amount of used contents. A navigation system is also disclosed. The navigation system enables the user to lock the use permission, issue a refund request after use permission locking, and unlock the use permission lock.

### BACKGROUND OF THE INVENTION

1. Field of the Invention

The invention relates to a method of and system for selling an information package that contains a plurality of charged contents (or pieces of charged information) with a capability of providing a refund in response to the amount of actually used contents and a consuming device or system, for use in such a system, that uses one or more content of such an information package.

2. Description of the Prior Art

A term “information package” used herein means any commercially distributable unit that contains a plurality of charged software contents. Some of such information packages are a music album CD-ROM (compact disc-read only memory) that contains several pieces of music, an atlas CD-ROM that contains area maps covering a nation for use in a car navigation system, an encyclopedia DVD (digital versatile disc) that contains an enormous number of items, etc. The information packages may take the form of either portable mass storage media such as various optical discs, memory cards, etc. or data sets downloadable either from a web site of an information vendor through the Internet or from any service point of the information vendor via any transmission media.

We take, as an example, a car navigation system that uses a map data optical disc storing a map database in the following.

In a car navigation system, maps that cover areas along a route leading from the current position to the destination are displayed by reading necessary pieces of map data out of the map data optical disc on which a map database is stored. In case of such car navigation systems, data for areas around the user's residence are often used. However, in map data for areas (e.g., in Hokkaido or the northern end of Japan for a user living in Kyushu or the southern end of Japan's main land) far remote from his/her residence, there are many areas of map data that have never been used since he/she has bought the optical disc. Since such map data optical discs are usually sold for a price of the entire disc (i.e., the entire map data for all the areas of a nation), purchasing a map data optical disc is to pay for more information than actually necessary. This may cause the user to hesitate to buy a revised version of the optical disc which is released almost every year.

The same situations as described apt to occur in other systems that use respective information packages that each contain a plurality of charged contents.

The present invention has been made to overcome the above and other problems and contribute to the advance in the art.

Accordingly, it is an object of the invention to provide a information consuming device that works by using a content of an information package that contains a plurality of charged contents that permits the user to get a refund in response to the amount of actually used contents.

It is another object of the invention to provide a program, run on a computer, for effecting a specific function by using a content of an information package containing a plurality of charged contents while permitting a user to get a refund in response to the amount of actually used contents.

It is further object of the invention to provide an information package that contains a plurality of charged contents and a program that enables the user to get a refund in response to the amount of actually used contents.

### SUMMARY OF THE INVENTION

According to an aspect of the invention, there is provided a consuming device for effecting a specific function by using a content of an information package containing a plurality of charged contents while permitting a user to get a refund in response to the amount of actually used contents. The consuming device comprises an information consuming portion for using a content of the information package and a controller. A used content ID list of IDs of charged contents having been used so far is stored in nonvolatile memory in such a way as prevents the list from being altered by any person. If a content to be used has never been used until then, the controller adds the ID of the content to used content ID list.

A navigation system is disclosed as an embodiment. The navigation system enables the user to lock the use permission, issue a refund request after use permission locking, and unlock the use permission lock.

According to another aspect of the invention, there is provided a program, run on a computer, for effecting a specific function by using a content of an information package containing a plurality of charged contents and permitting a user to get a refund in response to the amount of actually used contents. The program comprises the functions of using a content of the information package; maintaining a used content ID list of IDs of charged contents having been used so far in such a way as prevents the list from being altered by any person; and if a content to be used has never been used until then, adding the ID of the content to the list.

According to further aspect of the invention, an information package for use in a computer-based system is provided. The information package comprises a plurality of charged contents; identifiers (IDs) assigned to respective charged contents; and the above-mentioned program.

### BRIEF DESCRIPTION OF THE DRAWING

Further objects and advantages of the present invention will be apparent from the following description of the preferred embodiments of the invention as illustrated in the accompanying drawing, in which:

FIG. 1 is a diagram illustrating the basic concept of a method of and a system for selling an information package that contains a plurality of charged contents with a capability of providing a refund in response to the amount of actually used contents;

FIG. 2 is a diagram showing an exemplary structure of data contained in an information package loaded into and used an information consuming device 20 in the system 1 of FIG. 1;

FIG. 3 is a diagram showing an information package and user management table maintained by the management center 40 of FIG. 1;

FIG. 4 is a schematic block diagram showing an exemplary arrangement of an information consuming device 20 according to the principles of the invention;

FIG. 5 is a diagram showing exemplary contents of the nonvolatile memory 216 of FIG. 4;

FIG. 6 is a diagram showing the information package 30 that further includes the control program 212 of FIG. 4;

FIG. 7 is a flowchart showing an exemplary monitoring operation executed when any of the contents in the information package 30 is to be accessed;

FIG. 8 is a flowchart showing a charge and expected refund amount report operation executed in response to a predetermined command from the user 10;

FIG. 9 is a flow diagram showing a refund operation cooperatively executed by information consuming device 20 and administration center 50 in response to a refund command issued by the user 10;

FIG. 10 is a diagram showing an exemplary structure of a price table the administration center 50 maintains for each kind of information packages;

FIG. 11 is a schematic diagram showing an arrangement of a car navigation system in accordance with an illustrative embodiment of the invention;

FIG. 12. is a diagram showing an exemplary menu for the use of map data;

FIG. 13 is a flowchart showing an operation of using a new area map which is executed in response to a selection of “New Area Map” button 452 of FIG. 12;

FIG. 14 is a diagram showing an exemplary map selection display screen;

FIG. 15 is a diagram showing an exemplary way of selecting an area such that the selected are is freely defined by the user;

FIGS. 16A through 16C are exemplary price reference tables for use in finding the price of a given area;

FIG. 17 is a price correction rate table with which the calculated price of a given area is adjusted according to the elapsed days from the map disc 30 release;

FIG. 18 is a flowchart showing an exemplary use permission locking operation executed in response to a selection of a “Use Permission Lock” button 454 of FIG. 12;

FIG. 19 is a diagram showing an exemplary use permission lock approval screen; and

FIG. 20 is a flow diagram showing a use permission lock unlocking operation according to an illustrative embodiment of the invention.

Throughout the drawing, the same elements when shown in more than one figure are designated by the same reference numerals.

### DETAILED DESCRIPTION OF THE PREFERRED EMBODIMENTS

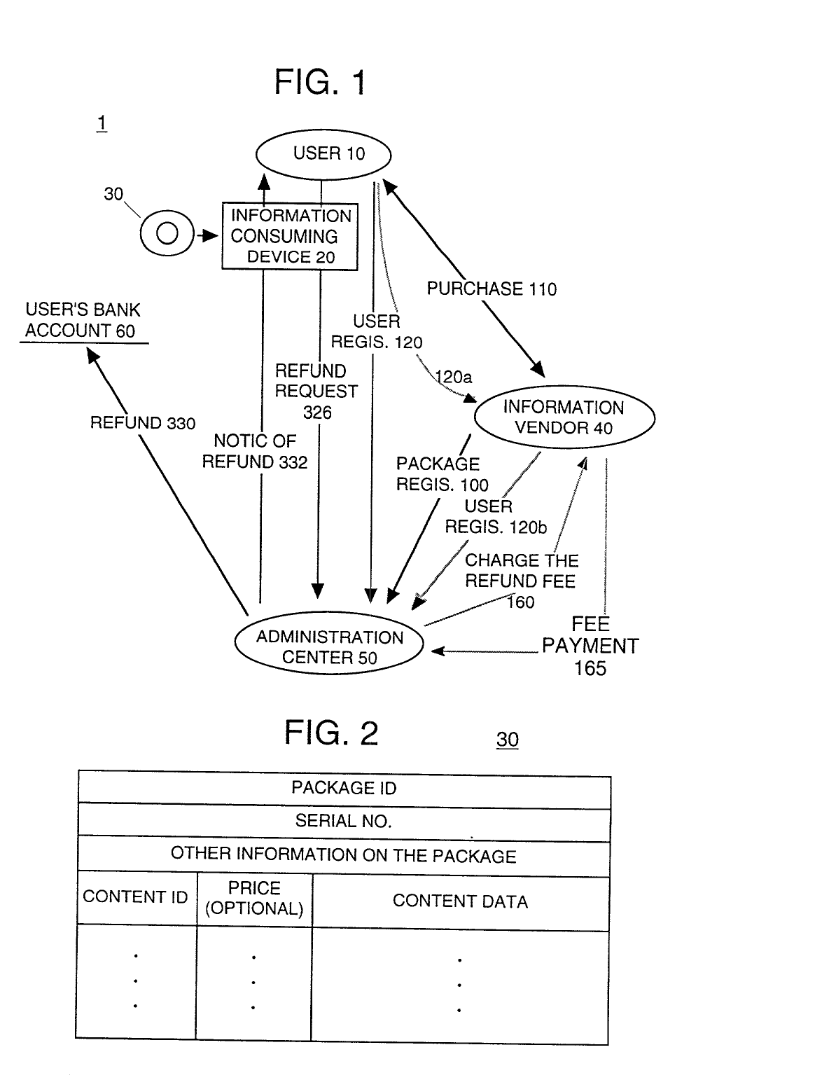

FIG. 1 is a diagram illustrating the basic concept of a method of and a system for selling an information package that contains a plurality of charged contents with a capability of providing a refund in response to the amount of actually used contents. In FIG. 1, if an information vendor 40 desires to sell a certain kind of information packages 30 in accordance with the principles of the invention, then the vendor 40 preferably arranges the format of the information packages 30 as shown in FIG. 2. In FIG. 2, each information package 30 has a format that includes a package ID for identifying the kind of the package, a serial number of the package and other information on the kind and/or the package. The information packages 30 further includes, for each of the contents, the content ID for identifying the content and the content data. The package may optionally include the price of each content.

Prior to selling the information packages, the information vendor 40 registers 100 the information packages by sending a list of the serial numbers of the packages to an administration center 50 in step 100. The center 50 stores the received serial number list.

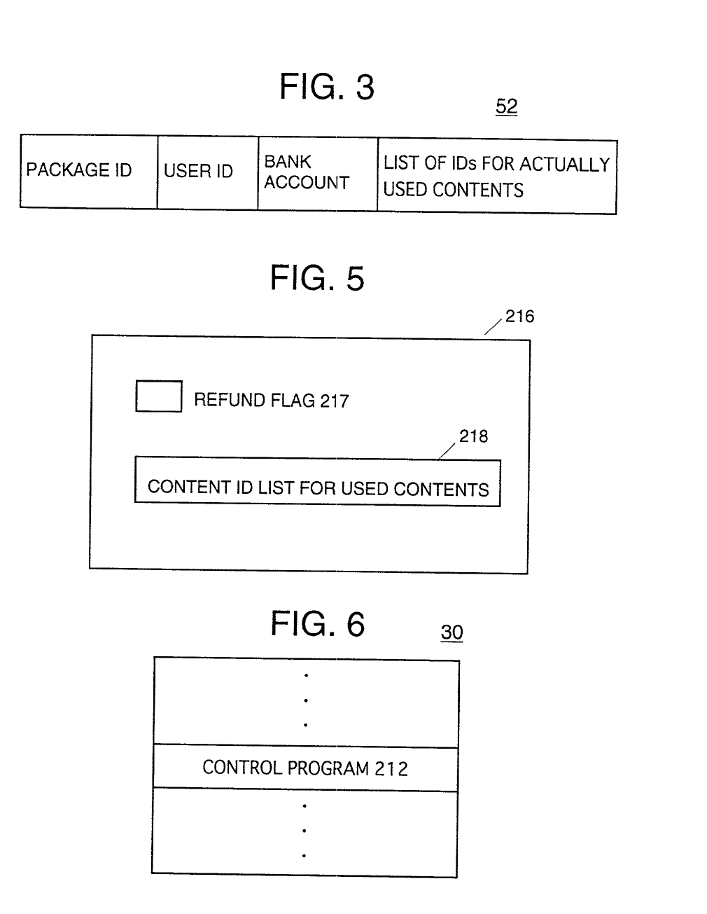

When a user 10 buys one of information packages 30 at a store (not shown) or from a web site (not shown) in step 110, he/she may register himself/herself either with information vendor 40 from the store on the spot in step 120a or with administration center 50 through the Internet (not shown) later in step 120. In either case, the user 10 reports his/her bank account 60 to vendor 40 or administration center 50 so that he/she can get a refund through bank account 60 and has a user ID issued by vendor 40 or center 50. If the user 10 has been registered with information vendor 40, then vendor 40 in turn registers the user 10 with center 50 by sending the serial number of the purchased package 30, the user ID and the user's bank account to center 50 in step 120b. In either case 120 or case 120a plus 120b, administration center 50 registers the purchase of the information package 30 of the serial number by the user. FIG. 3 diagram shows an information package and user management table 52 maintained by the management center 40 for this purpose. The registration is achieved by adding a record for the purchased package 30 to the table 52. Each record of information package and user management table 52 comprises a package serial number field, a user ID field, a bank account field, and a field for storing a list of IDs for actually used contents.

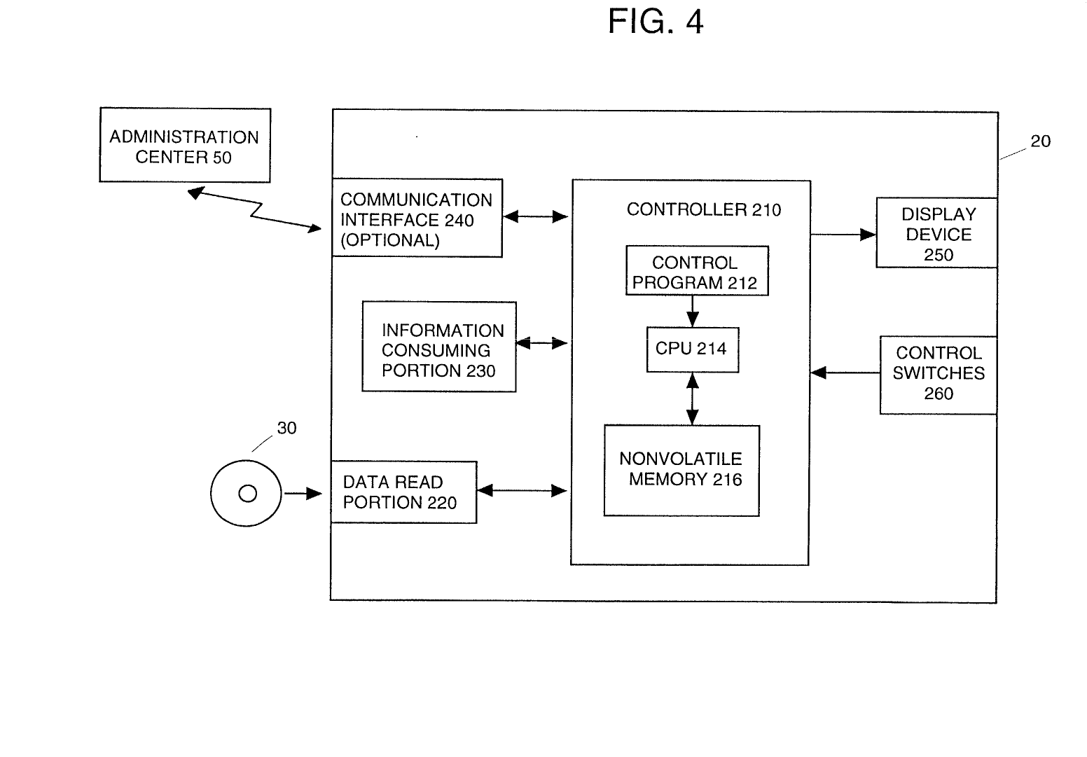

Then, the user 10 can use the information package 30 with an information consuming device 20. FIG. 4 is a schematic block diagram showing an exemplary arrangement of an information consuming device 20 according to the principles of the invention. In FIG. 4, device 20 comprises a controller 210 for controlling the entire device 20; a data read portion 220 for reading a piece of content data from the information package 30; an information consuming portion 230 which uses the read piece of content data to effect a function specific to the device 20; a display device 250 for visually displaying various information; and control switches 260 through which the user operates the device 20. The information consuming device 20 preferably includes a communication interface 240 that enables a communication with administration center 20 through the Internet but can be implemented without using any communication interface 240. The controller 210 includes a well-known CPU 214, a control program 212 for controlling the operation of device 20 or CPU 214 and a nonvolatile memory 216. FIG. 5 shows exemplary contents of the nonvolatile memory 216. As shown in FIG. 5, the nonvolatile memory 216 at least stores a refund flag 217 indicative of whether the user has already got a refund or not and a content ID list 218 for ever accessed or used contents. It is assumed that the initial value of the refund flag 217 is 0, which means that the user has not received any refund. It is preferable to store the content ID list 218 such that the content ID list 218 is not easily read out or altered. For this, the content ID list 218 may be encrypted with any suitable encryption method.

The information consuming device 20 may be either a dedicated device dedicated to a specific application such as a navigation system, an electronic book, a music player, etc. or any suitable computer or portable information terminal on which the control program 212 can be successfully executed. In the latter case, the control program 212 may be either downloaded from a web site or a service point of the information vendor 40 or included in the information package 30 as shown in FIG. 6.

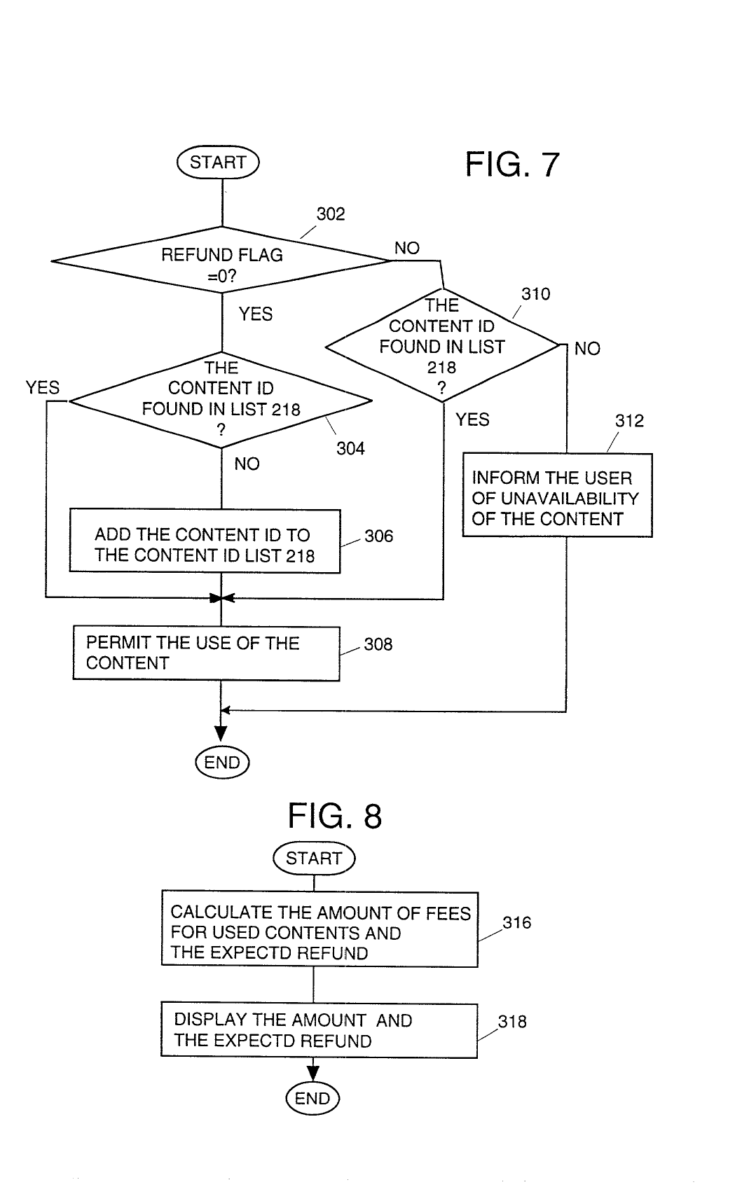

During the use of information package 30, the control program 212 monitors each access to the information package 30. FIG. 7 is a flowchart showing an exemplary monitoring operation executed when any of the contents in the information package 30 is to be accessed in accordance with the invention. In FIG. 7, CPU 214 makes a test to see if the refund flag 217 is 0 in step 302, then CPU makes another test to see if the ID of the content to be accessed is found in the content ID list 218 for the used contents in step 304. If so, meaning that the content data identified by the content ID has been already accessed, then CPU 214 permits the use of the content in step 308 and ends the monitoring operation. If the test result is NO in step 304, then CPU 214 adds the content ID to the content ID list 218 in step 306 and proceeds to the above-described step 308. On the other hand, if the refund flag is not 0, meaning that the user 10 has already received a refund, then CPU 214 again makes a test to see if the ID of the content to be accessed is found in the content ID list 218 for the user contents in step 210. If so, then CPU 214 proceeds to step 308 and permits the use of the content identified by the content ID and ends the monitoring operation. If the test result is NO in step 310, which means that the content to be accessed has never been accessed or used so far and accordingly is not available to the user 10, then CPU 214 informs the user 10 of unavailability of the content identified by the content ID.

Doing this enables the user 10 to use the contents of the information package 30 freely as long as the user 10 does not receive a refund while prohibiting the user from accessing any new content (i.e., any content that has never been used so far) after a refund has been executed.

If information package 30 contains, for each content, the price for the content or if information package 30 contains the price common to all the contents in any of the “other information” fields when all the contents are equally priced, then the information consuming device 20 can calculate 316 and display 318 the amount of fees for the contents that have been used so far and the expected amount of a refund that the user 10 could receive at present as shown in FIG. 8. In this case, the amount of fees for the used contents is given as a function of the prices assigned to the contents in the content ID list 218 in the nonvolatile memory 216. In the simplest case, the amount of fees is given as the sum of the prices. And, the expected amount of a refund is calculated from the price of information package 30 and the calculated amount of fees.

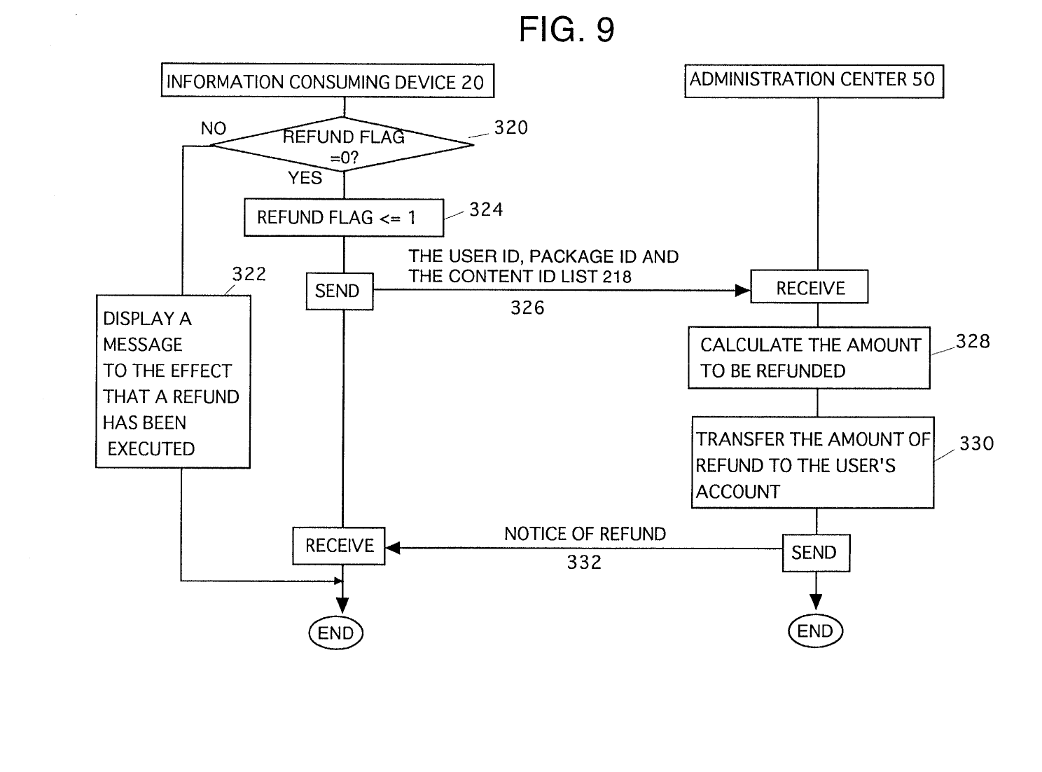

FIG. 9 is a flow diagram showing a refund operation cooperatively executed by information consuming device 20 and administration center 50. If the user 10 issues a refund command, then CPU 214 enters the operation of FIG. 9. In FIG. 9, CPU 214 makes a test to see if the refund flag is 0 in step 320. If not, which means that a refund has been already executed, then CPU 214 displays a message to this effect in step 322 and end the operation.

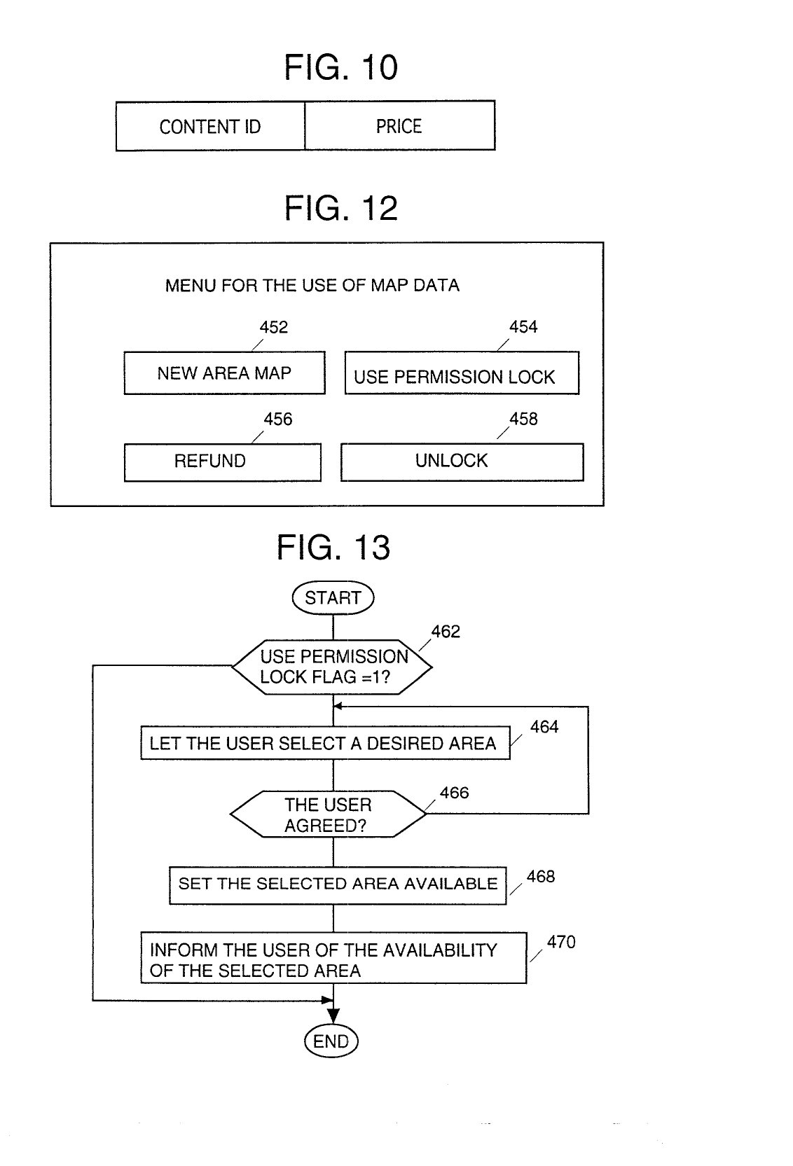

If the test result is YES in step 320, then CPU 214 sets the refund flag to 1 in step 324 and sends the user ID, the package ID, and the content ID list 218 for the used contents to administration center 50 in step 326. Administration center 50 responsively calculates in step 328 the amount to be refunded in the same way as in case of step 316. For this purpose, administration center 50 has to have a price table as shown in FIG. 10. In step 330, administration center 50 transfers the amount of refund to the user's bank account. Then, administration center 50 sends a notice of refund informing that the refund procedure has been completed to information consuming device 20 in step 332, and ends the refund operation of the center 50. In response to a reception of the notice of refund, information consuming device 20 ends the refund operation thereof.

If the information vendor 40 and the administration center 50 are an identical company, then the above-described operation is complete. However, if the information vendor 40 and the administration center 50 are different companies, then the center 50 charges 160 the information vendor 40 for the refund fee; and the information vendor 40 pays 165 the refund fee to the center 50 as shown in FIG. 1. The information vendor 40 and the administration center 50 are referred to, en bloc, as “the information vendor (or provider) side”.

According to the principles of the invention, the user can get a refund depending on the amount of contents he/she has been used until then.

Embodiment: Car Navigation System.

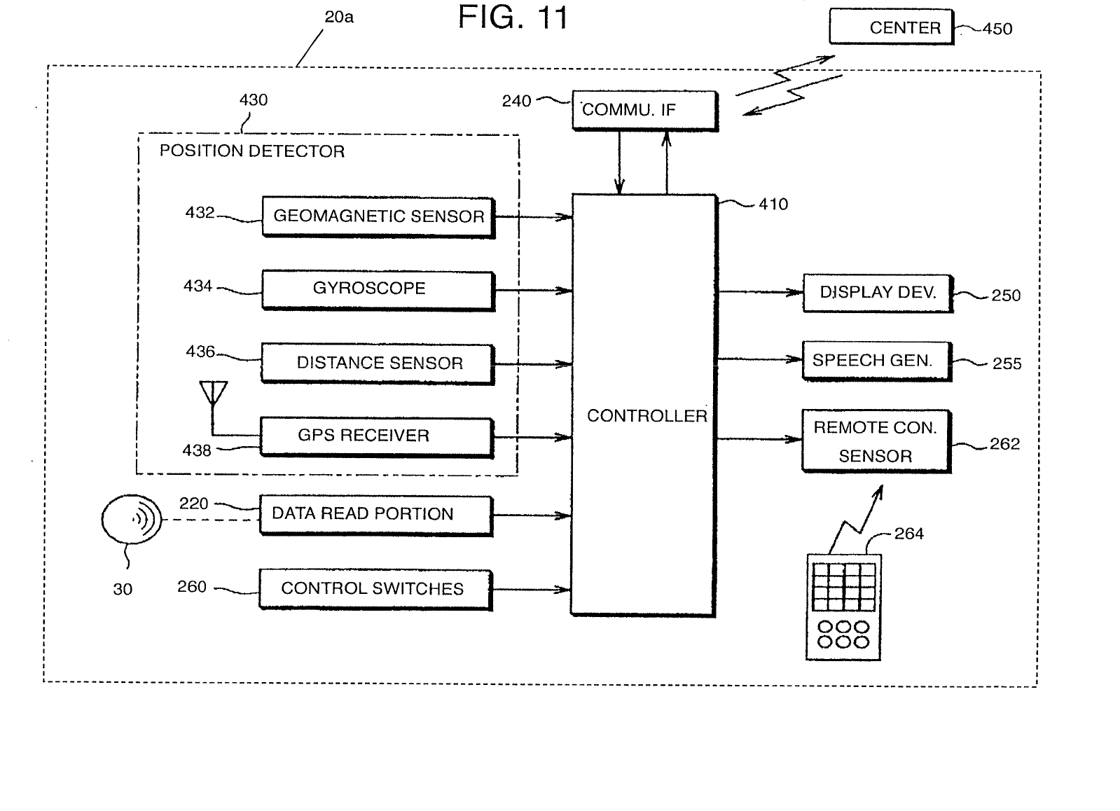

FIG. 11 is a schematic diagram showing an arrangement of a car navigation system in accordance with an illustrative embodiment of the invention. The car navigation system comprises a car navigation device 20a and an administration center 450. Since the navigation device 20a of FIG. 1 is vary similar to the information consuming device 20 of FIG. 4, only the differences will be described in the following. In FIG. 11, controller 210, administration center 50 and information consuming portion 230 have been replaced with controller 410, administration center 450 and information consuming portion or position detector 430; and a speech generator 255, a remote controller sensor 262 and a remote controller 264 have been added. The position detector 430 comprises a geomagnetic sensor 432, a gyroscope 434, a distance sensor 436 and a GPS (global positioning system) receiver 438 as is well-known in the art. Controller 410 is identical, in structure, to controller 210 except for the stored program.

The controller 410 not only has a function of reading map data out of the map disc 30 through data read portion 220 and providing a driving guide on the basis of the read map data and the current position of the car but also has functions of setting a route to the destination on the basis of the map data read from the map disc 30 in response to an operation of the control switches 260 or the remote controller 264 which operation the user does in order to get a route guidance, providing a route guidance display through the display device 250, and generating a speech guidance concerning intersections through the speech generator 255.

FIG. 12. is a diagram showing an exemplary menu for the use of map data. In response to a predetermined operation by the user, controller 410 displays the menu of FIG. 12.

FIG. 13 is a flowchart showing an operation of using a new area map which is executed in response to a selection of “New Area Map” button 452 of FIG. 12. In FIG. 13, controller 410 makes a test in step 462 to see if a use permission lock flag is 1 or the use permission is locked. The use permission lock flag is basically the same as the above-described refund flag. However, the use permission lock flag can be set by the user when the user determines not to use a map for any new area.

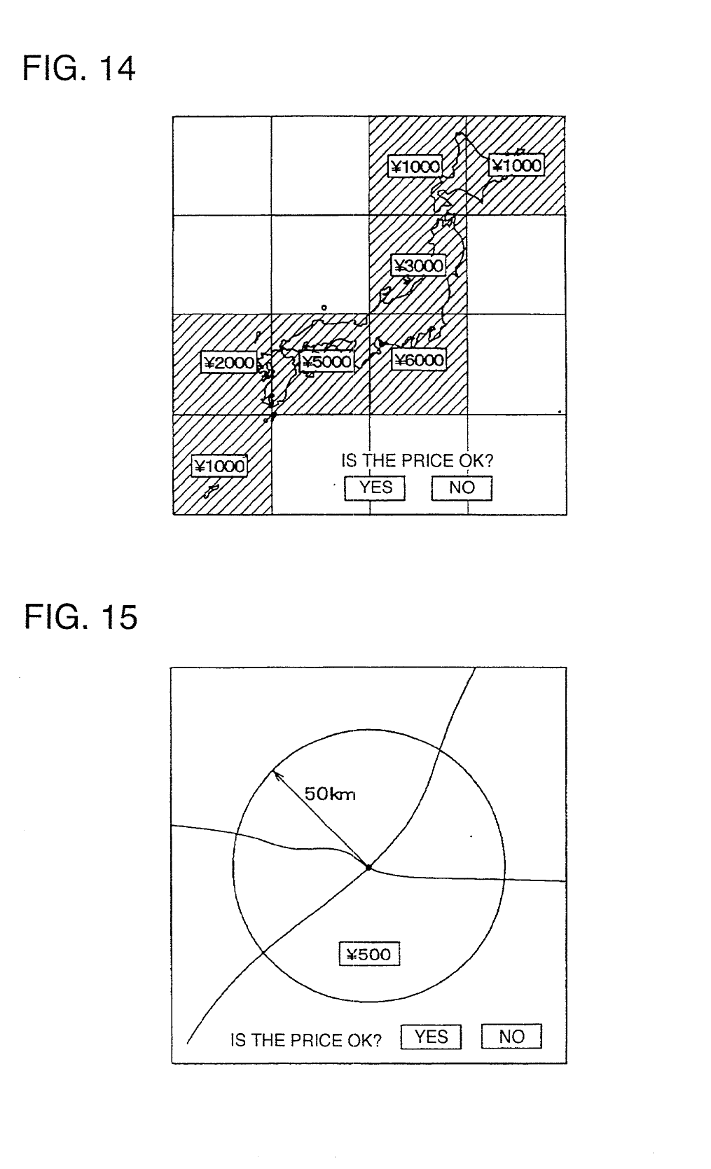

If the use permission lock flag is not 1, controller 410 displays a map selection screen as shown in FIG. 14. In FIG. 14, a map of the entire Japan is divided into small blocks in each of which the price for the map is displayed. In this case, the entire Japan may be divided into prefectures, each which is further divided into cities and so on, permitting the user to select one of larger areas, one of smaller areas in the selected area, and so on while displaying the price for each of such areas. Also, instead of selecting one of predetermined areas, the selection scheme may be so arranged as to enable the user to freely define a desirable area. FIG. 15 is a diagram showing an exemplary way of selecting an area such that the selected are is freely defined by the user. In an example of FIG. 15, the area selection is so arranged as to enable the user to select an area within a radius of, say, 50 km from a user specified point.

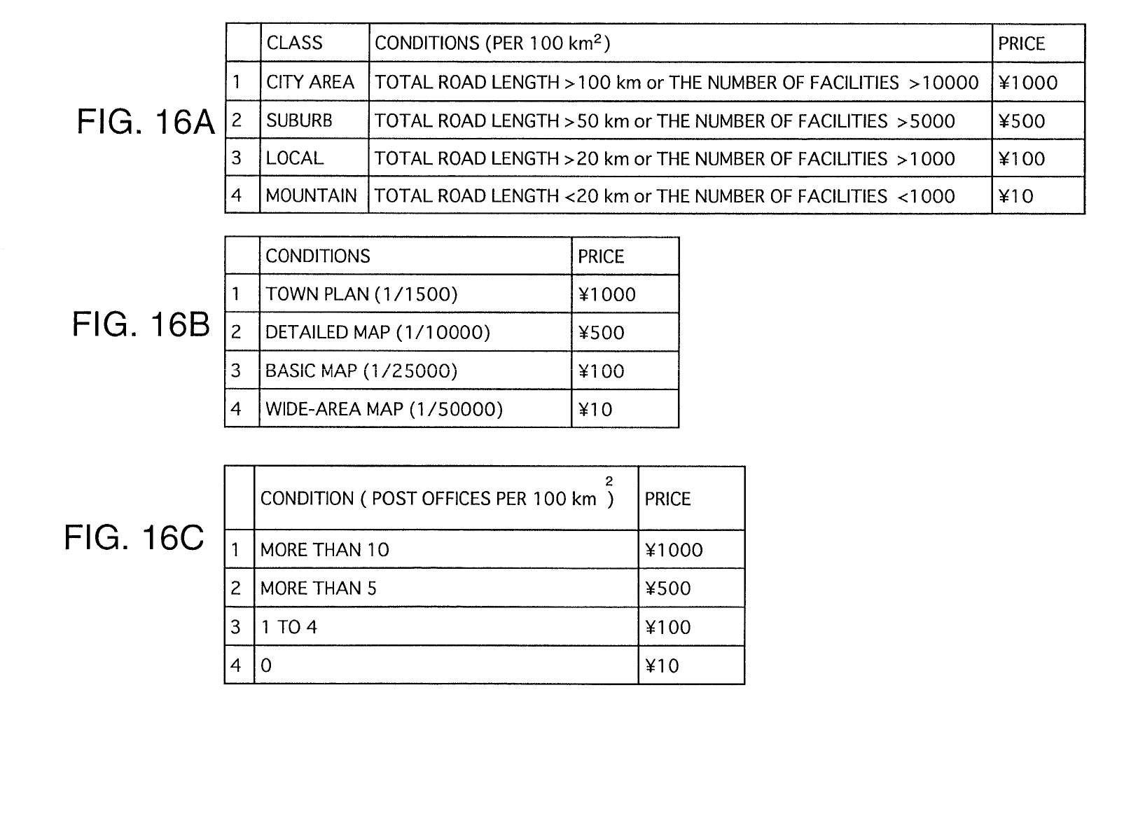

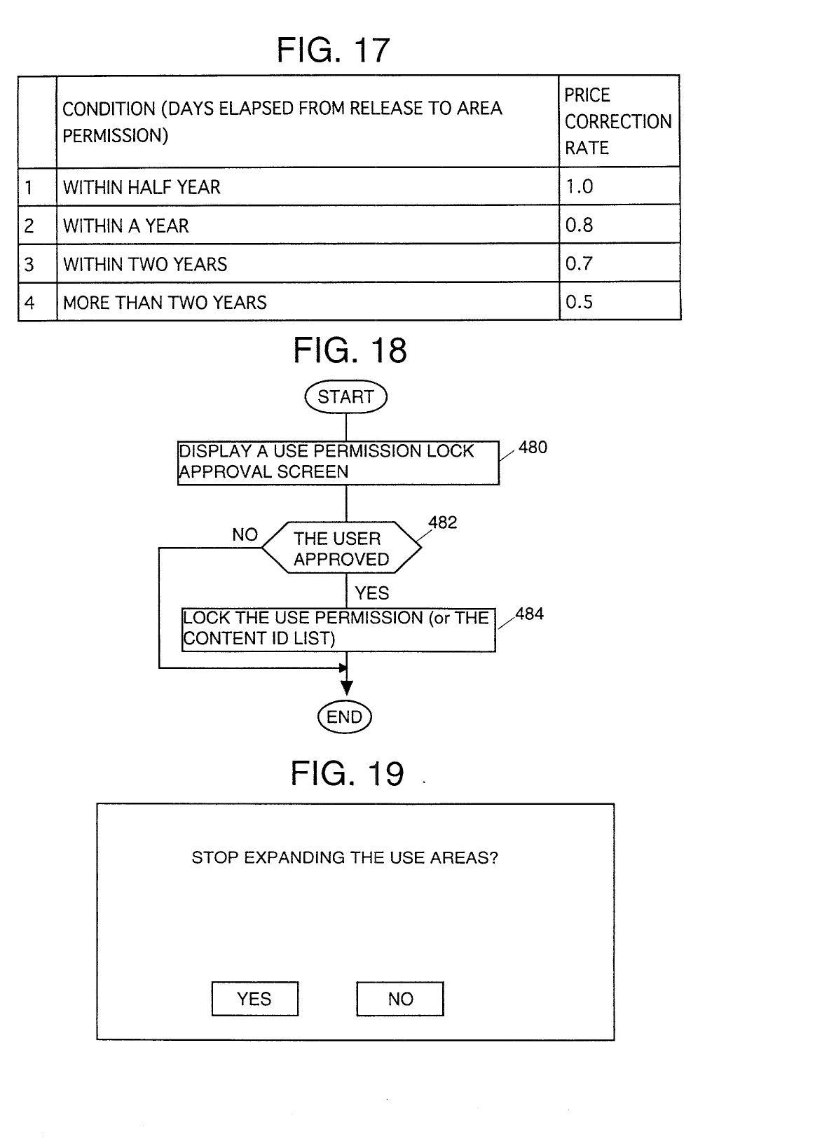

In case of the user defining a selection area, the price of the userdefined area can be defined on the basis of the amount of data on roads, facilities, etc. included in the user-defined area. Specifically, controller 410 calculates the total distance of the roads, the number of facilities and landmarks and the area included in a user-defined area or a divided block the user selected. For this purpose, the navigation system is preferably provided with any of price reference tables as shown in FIGS. 16A through 16C. For example, the unit price per unit area is determined from the table of FIG. 16A, and the price of the specified area is determined by multiplying the unit price by the area of the specified area. In this case, an arrangement may be so made as to enable an exact map selection by adopting or rejecting data on the basis of the detail level or the scale as defined in table of FIG. 16B.

The price of each map may be also determined in many ways other than described above. For example, post offices or elementary schools are thought to be set up according to the population density, the price of an area can be easily approximated by counting the number of the post offices and/or elementary schools included in the area. For this purpose, a table as shown in FIG. 16C is useful.

It is noted that map data tend to lose its accuracy (due to additions, alterations and deletions of roads, facilities, etc. for example) as time goes by. Taking this fact into account, the navigation system may be so configured as to reduce the prices of the map data in response to the time lapsed from the release of the map disc 30. For example, the prices of map data are adjusted by multiplying the above-calculated map data price by a correction rate response to the days elapsed from the disc 30 release.

Turning back to FIG. 13, controller 410 makes a test to see if the user agreed with the price in step 466. If so or the user touches a “YES” button in FIG. 14 or 15, then controller 410 sets the map data for the selected area available to the user in step 468. Specifically, the selected area is so stored in the nonvolatile memory as to be difficult to be read by the user. (If the areas have respective IDs, this is achieved by using the content ID list for the used contents of FIG. 5. If the selected area is a user-defined one, then this is achieved not by using a single ID but by using the ID assigned to the user-defined area and the data that defines the user-defined area.) Then, controller 410 informs the user to the effect that the desired area has become available in step 470 and ends the operation.

Since the above-described process involves a charging, it is preferably to set a password to the process so as to prevent irregular use by others. Also, agreement it is preferable to get the user's agreement more than twice in step 466. The navigation system may be so configured as to permit the user to cancel the new area use registration within a predetermined period of time (e.g., 10 minutes) after the registration.

It is also noted that, each time of accessing to any area of the map disc 30, controller 410 checks the availability of the area as described in connection with the flowchart of FIG. 7. In this case, the use permission lock flag is identical to the refund flag.

Locking the use permission (or the content ID list)

According to this embodiment of the invention, the user can stop the new area use registration function at any time when the user determines not to use any more new area. For this purpose, the user has only to specify the “Use Permission Lock” 454 in the menu screen of FIG. 12.

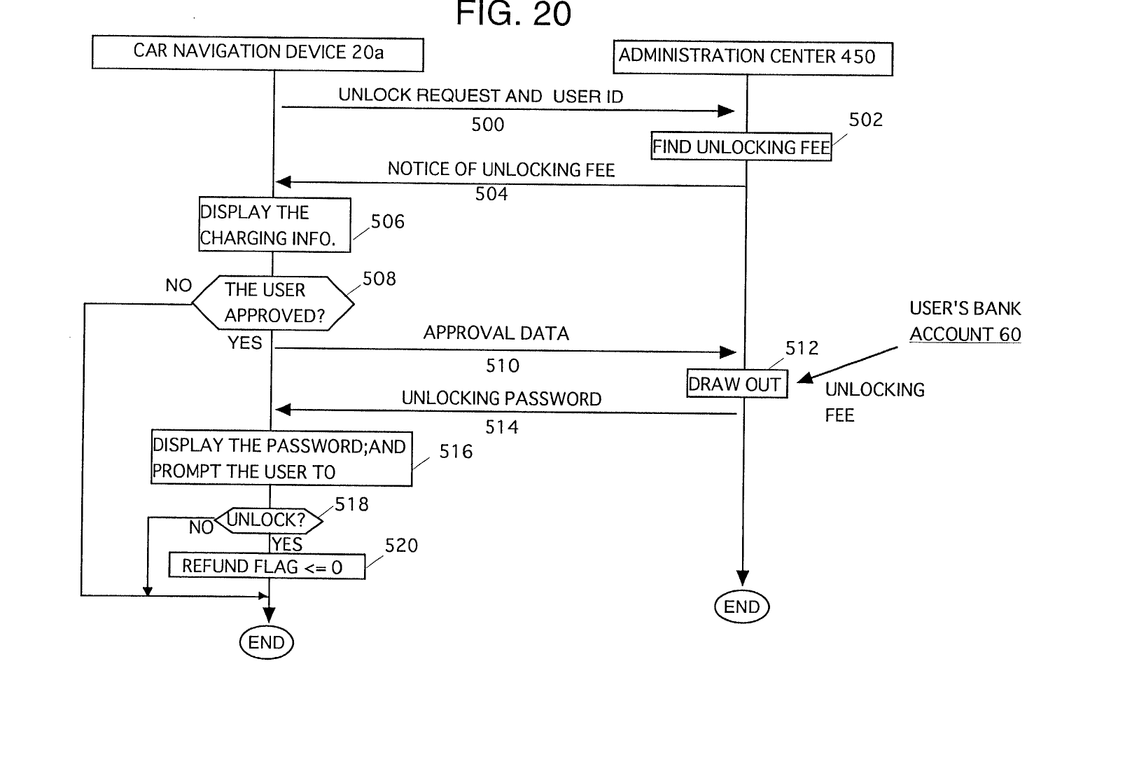

FIG. 18 is a flowchart showing an exemplary use permission locking operation executed in response to a selection of “Use Permission Lock” 454 of FIG. 12. In FIG. 18, controller 410 first display a use permission lock approval screen as shown in FIG. 19 in step 480. In step 482, controller 410 makes a test to see if the user approves the locking of the use permission (or the stoppage of expanding the use areas). If not, controller 410 simply ends the operation. If the user approves the locking of the use permission by touching a “YES” button in step 482, then controller 410 lock the use permission or the content ID list 218 in the nonvolatile memory 216 by setting the use permission flag or the refund flag 217 in step 484 and ends the operation.

Setting the refund flag 217 disables the expansion of the content ID list 218 as shown in the flowchart of FIG. 7, which determines the unused contents or areas. Accordingly, this enables a refund for the unused areas.

The refund for the unused areas is executed as described in connection with the flow diagram of FIG. 9. In this case, the center 450 preferably stores the amount of refund in the information package and user management table 52 of FIG. 3 so that the refund amount can be used for an unlock process detailed later.

Unlocking the use permission lock

The user can not expand the available areas after the refund. However, it is probable that the user desires to use maps for new areas after the refund. For this purpose, a navigation system according to this embodiment of the invention is so arranged as to permit the user to unlock the use permission lock by executing a predetermined operation: e.g., touching an “Unlock” button 458 in the menu screen of FIG. 12.

FIG. 20 is a flow diagram showing a use permission lock unlocking operation executed in response to an unlock 458 command from the user. In FIG. 20, the car navigation device 20a or controller 410 sends an unlock request and the user's ID to the administration center 450. In response to the unlock request, the center 450 finds an unlocking fee by obtaining the refund amount from the information package and user management table 52 and, if necessary, adding a handling fee to the refund amount in step 502. In step 504, the center sends a notice of the unlocking fee to the navigation device 20a.

In response to the notice, the navigation device 20a displays the notice of the unlocking fee in step 506 and makes a test, in step 508, to see if the user approves the payment of the unlocking fee. If not, then controller 410 simply ends the unlocking operation. If the user approves in step 508, then controller sends approval data to the center 450 in step 510.

The center 450 responsively draws the unlocking fee from the user's bank account 60 in step 512 and sends an unlocking password to the navigation device 20a in step 514.

Then, controller 410 responsively displays the unlocking password and prompts the user to enter the unlocking password to unlock the use permission lock in step 516. Controller 410 further makes a test to see if the user enters the unlocking password for the unlocking in step 518. If not, then controller 410 simply ends the unlocking operation. If the test result is YES in step 518, then controller 410 unlocks the use permission lock by resetting the use permission lock flag or refund flag in step 520, and ends the unlocking operation. Doing this enables the user to use map data for any new area again.

Modification

In the above-described embodiment, the refund is carried out through communications between the information consuming device 20 or 20a and the center 50 or 450, the refund may be implemented by the user carrying the information consuming device 20 or 20a in a specific facility such as the center 50 or 450, an information vendor 4, etc. and reading out the used content ID list 218 from the nonvolatile memory 216 with a dedicated data reader. In this case, if the map disc 30 is returned to the specific facility, then the use permission has not necessarily been locked.

In the above embodiment, the amount of refund has been calculated in the center 50 or 450. However, the amount of refund may be calculated in the information consuming device 20 or 20a and transmitted to the center 50 or 450. In this case, the amount of refund may be Calculated from either unused contents or used contents. Also, the amount to be refund may be sent to a specific facility other than the center 50 or 450.

In the above embodiment, only use-permitted content is read out of the information package 30. However, the information consuming device 20 or 20a may be so arranged as to use only use-permitted content from the contents read out of the information package 30.

In order to prevent the refund flag 217 and the used content ID list 218 from being unjustly changed, it is preferable to store the refund flag 217 and the used content ID list 218 in an encrypted form.

If the information package 30 includes a RAM (random access memory) area, then the refund flag 217 and the used content ID list 218 may be encrypted and stored in the RAM area of the information package 30.

Many widely different embodiments of the present invention may be constructed without departing from the spirit and scope of the present invention. It should be understood that the present invention is not limited to the specific embodiments described in the specification, except as defined in the appended claims.

What is claimed is:

1. A consuming device for effecting a specific function by using a content of an information package containing a plurality of charged contents while permitting a user to get a refund in response to the amount of actually used contents, the consuming device comprising:
means for using said content of said information package;
means for storing information to know whether each of said charged contents has been used so far;
means, responsive to a determination that said content to be used has never been used, for registering to the effect as said information; and
means, responsive to a determination that the user has already got said refund and said content to be used has never been used, for prohibiting a use of said content to be used.

2. A consuming device as defined claim 1, further comprising means, responsive to a refund request from the user, for sending a signal indicative of said refund request and a user ID of the user to a vendor side from which the user has bought said information package.

3. A consuming device as defined claim 1, wherein said means for storing information comprises means for storing a list of identifiers (ID s) of the used contents having been used so far, and wherein said registering means includes means for adding an ID of said content to be used.

4. A consuming device as defined claim 2, wherein said means for prohibiting a use of said content includes a flag indicative of whether the user has already got said refund.

5. A consuming device as defined claim 4, wherein said means for sending a signal indicative of said refund request includes means for setting said flag to 1.

6. A consuming device as defined claim 1, further comprising selection means for permitting the user to select, as said content, a desired one of said charged contents, said selection means including means for displaying the price of said selected content.

7. A consuming device as defined claim 1, further comprising means, responsive to a predetermined input by the user, for displaying an expected amount of a refund that the user could receive at present.

8. A navigation system that uses a map of an optical disc containing a plurality of charged maps of data and permits a user to get a refund in response to the amount of actually used maps, the navigation system comprising:
means for using said map of said optical disc;
means for storing information to know whether each of said charged maps has been used so far;
means, responsive to a determination that said map to be used has never been used, for registering to the effect as said information; and
means, responsive to a determination that the user has already got said refund and said map to be used has never been used, for prohibiting a use of said map to be used.

9. A navigation system as defined claim 8, further comprising selection means for permitting the user to select, as said map, a desired one of said charged maps, said selection means including means for displaying the price of said selected content.

10. A navigation system as defined claim 9, wherein said selection means comprises means for permitting the user to define an area and wherein said means for displaying the price of said selected content includes means for calculating said price on the basis of the amount of data included in said selected area.

11. A navigation system as defined claim 10, wherein said means for calculating said price includes means for correcting said calculated price according to the elapsed time from release of said optical disc.

12. A navigation system as defined claim 8, wherein said means for prohibiting a use of said map includes a flag indicative of whether the user has already got said refund.

13. A navigation system as defined claim 12, further comprising flag setting means for permitting the user to set said flag so as to cause said flag to indicate that no new map is available.

14. A navigation system as defined claim 13, further comprising means, responsive to a refund request issued from the user after said setting of said flag, for sending a signal indicative of said refund request and a user ID of the user to a vendor side from which the user has bought said information package.

15. A navigation system as defined claim 14, further comprising:
means for permitting the user to issue a flag resetting command;
means, responsive to a reception of a notice of a refund fee, for asking the user if the user agrees to pay said refund fee;
means, responsive to an agreement by the user, for prompting the user to do a further operation to reset said flag; and
means, responsive to said further operation, for resetting said flag.

16. A program, run on a computer, for effecting a specific function by using a content of an information package containing a plurality of charged contents while permitting a user to get a refund in response to the amount of actually used contents, the program comprising the functions of:
using said content of said information package;
storing a list of IDs of charged contents having been used so far in such a way as prevents said list from being altered by any person; and
if said content has never been used, adding an ID of said content to said list.

17. An information package for use in a computer based system, the information package comprising:
a plurality of charged contents;
identifiers (IDs) assigned to respective charged contents;
a program for effecting a specific function by using one of the charged contents and permitting a user to get a refund in response to the amount of actually used contents, the program comprising the functions of:
using said content of said information package;
storing a list of IDs of charged contents having been used so far in such a way as prevents said list from being altered by any person; and
if said content has never been used, adding an ID of said content to said list.
